(19) United States
(12) Patent Application Publication
(10) Pub. No.: US 2026/0312088 A1
(43) Pub. Date: Oct. 8, 2026

(54) FUEL CELL SYSTEM WITH IMPROVED HUMIDIFIER

(71) Applicant: PLASTIC OMNIUM NEW ENERGIES FRANCE, Lyon (FR)

(72) Inventors: Ewald WAHLMUELLER, Bruxelles (BE); Martin BUCHINGER, Bruxelles (BE); Christoph AHAMER, Bruxelles (BE); Matthias ZARHUBER, Bruxelles (BE); Bernhard SCHOBESBERGER, Bruxelles (BE); Gerald FEICHTINGER, Bruxelles (BE); Jurgen DEDEURWAERDER, Bruxelles (BE)

(73) Assignee: PLASTIC OMNIUM NEW ENERGIES FRANCE, Lyon (FR)

(21) Appl. No.: 19/481,471

(22) PCT Filed: May 20, 2024
(86) PCT No.: PCT/EP2024/063861

§ 371 Date: Nov. 4, 2025

(30) Foreign Application Priority Data
May 19, 2023 (EP) 23305803.1

(51) Int. Cl. H01M 8/04119; H01M 8/04029; H01M 8/04111; H01M 8/04746; H01M 8/04828

(52) U.S. Cl. CPC H01M 8/04141; H01M 8/04029; H01M 8/04111; H01M 8/04164; H01M 8/04776; H01M 8/04828; H01M 2250/20

(57) ABSTRACT

A fuel cell system includes: a fuel cell stack including an anode and a cathode; a cathode supply device providing a cathode inlet with a gas including air and water; an air compressor arranged between the cathode supply device and the cathode; a first dosing device and a second dosing device, the first dosing device injecting water upstream of the air compressor, and the second dosing device injecting water downstream of the air compressor; and a heat exchanger arranged upstream of the air compressor, the heat exchanger receiving heat from a cooling circuit of the fuel cell stack and/or from a motor of the air compressor.

The invention relates to fuel cell systems. More precisely, the invention relates to a fuel cell system for a stationary or a mobile equipment, a vehicle comprising such a fuel cell system and a method for managing such a fuel cell system.

An archetypical hydrogen-oxide proton-exchange membrane fuel cell (PEMFC) comprises an electrolyte solution contained in a proton-conducting membrane arranged between an anode and a cathode, this assembly forming what is commonly called a stack. In a generally known way, the anode is fed with a hydrogen-rich gas and the cathode is fed with a gas containing oxygen, air for example, in order to produce electrical power and, as a by-product, water at a cathode outlet.

To obtain good performance of the stack and minimize its degradation over time, the membrane of the stack needs a proper hydration at all states of operation of the fuel cell, such as start-up, steady state, dynamic load, and shutdown. Water produced at the outlet of the cathode may be used to hydrate the stack, however it is necessary to achieve a precise and controlled hydration so as to avoid flooding of the membrane or insufficient hydration, which both could be detrimental to the performance of the fuel cell. Oxygen contained in the air flow is a reactant of the reaction formed at the cathode side of the stack, and the air is enriched with gaseous water, i.e., water in gaseous form such as water vapor, at the cathode outlet. Depending on water concentration, i.e., humidity, temperature and pressure at the outlet of the cathode, the gaseous water can achieve over-saturated conditions and condensation can appear. The document DE 10 2020 206156 A1 discloses a fuel cell system comprising means for humidifying the cathode inlet.

It is known in the state of the art to use a passive humidifier in the stack arranged to transfer water from the cathode outlet to the cathode inlet without compromising the oxygen content of the air fed at the cathode inlet. Such passive humidifiers generally involve a porous membrane permitting a transfer of water at liquid state and a transfer of heat at the same time.

This type of passive humidifier does permit to achieve a humidification of the stack; however, it comes with several drawbacks. Indeed, such a passive humidifier is a bulky component which can be costly and complicated to fit in the fuel cell system. Moreover, the passive humidifier suffers from a generally poor lifespan due to the high temperatures it must withstand. It is possible to couple it to a charge air cooler for protecting the humidifier, but this comes with an additional cost and the constraint of an additional component to be integrated into the fuel cell system, which is why it is preferable to avoid having to rely on this component. In addition, by design, a passive humidifier does not allow dynamic management of water transfer from the cathode outlet to the cathode inlet, so that it cannot allow very satisfactory humidification of the stack in a certain number of configurations, which makes it somewhat rigid in its implementation.

In the view of above, there exists a need for a humidification system for a fuel cell which is more precise than the passive humidifier of the prior art and which allows a dynamic humidification of the stack.

To this end, it is provided according to the invention a fuel cell system, in particular for a vehicle, according to claim 1.

Thanks to the dosing devices, a highly precise and dynamic water management is enabled. The dosing devices can be commanded to inject water upstream from the cathode inlet on the basis of parameters of the stack and the gaseous flow of air and water fed into the cathode inlet. For example, when the gas entering the air compressor is too dry, the first dosing device humidifies the gas to a suitable humidity. In another example, when the gas exiting the air compressor is too hot, the second dosing device cools the gas down to a suitable temperature. Therefore, the dosing devices allow a controlled amount of water to be injected upstream and downstream of the air compressor in order to have the gas at a suitable water concentration, pressure and temperature for its entrance in the cathode inlet. Moreover, the dosing devices are less bulky than the passive humidifier of the prior art, making the fuel cell system according to the invention more compact. Additionally, the dosing devices have higher temperature tolerance than the passive humidifier of the prior art, which contributes to improve the lifespan of the fuel cell system.

Advantageously, the fuel cell system further comprises a control unit configured to control the opening and the closing of the first and second dosing devices.

The presence of the control unit together with the two injection points, upstream and downstream of the air compressor, allows to further control the dynamic water management by permitting to dynamically set the proportion of water being fed upstream and downstream of the air compressor depending on the parameters of the gaseous flow, improving the precision of the dynamic water management.

Advantageously, the fuel cell system further comprises a cathodic water separator, arranged downstream of a cathode outlet, the cathodic water separator being connected, directly or indirectly, to the first and second dosing devices.

This arrangement provides the advantage to recover the liquid water exiting from the cathode outlet for further water injection.

Advantageously, the fuel cell system further comprises an anodic water separator, arranged downstream of an anode outlet, the anodic water separator being connected, directly or indirectly, to the first and second dosing devices.

This arrangement provides the advantage to recover the liquid water exiting from the anode outlet for further water injection.

The expression “connected directly or indirectly” is intended to mean that another component may or may not be provided between the water separator and the first and second dosing devices.

The fuel cell system thus provides several sources of water for feeding the dosing devices. According to an embodiment of the invention, a buffer water tank is provided upstream of the dosing devices and downstream of the cathodic water separator and/or the anodic water separator. As such, the dosing devices can inject water towards the cathode inlet even if the water separators are not outputting water for a certain period of time.

Preferably, the fuel cell system further comprises a drain valve arranged between the anodic water separator and the cathodic water separator.

It is thus possible to drain the anodic water separator if need be.

Advantageously, the fuel cell system further comprises a water pump arranged upstream of the first and second dosing devices.

The presence of a water pump facilitates the feeding of the dosing devices with water.

Preferably, the fuel cell system further comprises a heater configured for heating the water in the pump.

Thanks to the heater, it is possible firstly to prevent the water in the pump and/or in the buffer water tank from freezing and secondly to thaw the water when it has frozen.

Advantageously, the first and second dosing devices each comprise an injector. The injector allows to create a water spray which facilitates the evaporation of said water.

According to the invention, the fuel cell system further comprises a heat exchanger arranged upstream of the air compressor. The heat exchanger is arranged to receive heat from a cooling circuit of the fuel cell stack and/or from a motor of the air compressor.

The heat exchanger allows to further facilitates the evaporation of the water contained in the gas before it is compressed. It is thus possible to inject a larger quantity of water while limiting water droplets entering the air compressor, which could damage the air compressor.

The air compressor is housed in a housing having an air inlet and an air outlet.

According to a first embodiment of the invention, the heat exchanger is arranged upstream of the air inlet of the air compressor, the heat exchanger is arranged to receive heat from a cooling circuit of the fuel cell stack and/or from a motor of the air compressor.

According to a second embodiment of the invention, the heat exchanger is arranged downstream of the air inlet of the air compressor such that the heat exchanger is integrated into the air compressor housing, the heat exchanger is arranged to receive heat from a cooling circuit of the fuel cell stack and/or from a motor of the air compressor.

The heat exchanger thus receives heat which is a by-product of another component of the fuel cell system, thereby improving the performance of the fuel cell system.

Advantageously, the fuel cell system further comprises a turbine arranged downstream of the cathode outlet.

The turbine allows to recover some of the energy of the gaseous flow exiting from the cathode outlet, thereby improving the performance of the fuel cell system.

Preferably, the turbine is arranged on a common shaft with the air compressor.

As such, the energy recovered by the turbine may be used by the air compressor, further improving the performance of the fuel cell system.

Preferably, the fuel cell system further comprises an auxiliary water separator arranged between the cathode outlet and the turbine.

The auxiliary water separator allows to reduce the water concentration of the gaseous flow entering the turbine. This reduces the risk of water droplets contained in the gaseous flow to damage the turbine blades.

It Is also provided according to the invention a vehicle comprising a fuel cell system as described above.

It Is also provided according to the invention a method for managing a fuel cell system as described above, involving opening and closing the first and second dosing devices to inject water partially upstream of the air compressor and partially downstream of the air compressor, and controlling the opening and the closing of the first and second dosing devices.

It Is also provided according to the invention a non-transitory computer readable storage medium for storing computer instructions, wherein the computer instructions, when executed by a computer, cause the computer to implement the method as described above, as well as a computer program product comprising computer program instructions, wherein the computer program instructions, when executed by a computer, cause the computer to perform the method as described above.

### BRIEF DESCRIPTION OF THE FIGURES

Other features and advantages would appear by reading the following description, given as an illustrative and non-restrictive example, and with the annexed drawings in which:

FIG. 1 is a schematical view of a fuel cell system according to a first embodiment of the invention, and

FIG. 2 is a schematical view of a fuel cell system according to a second embodiment of the invention.

### DETAILED DESCRIPTION

In the following description, the expressions “downstream” and “upstream” refer to the circulation direction of the various fluids in the fuel cell system, these directions being represented by arrows in the figures.

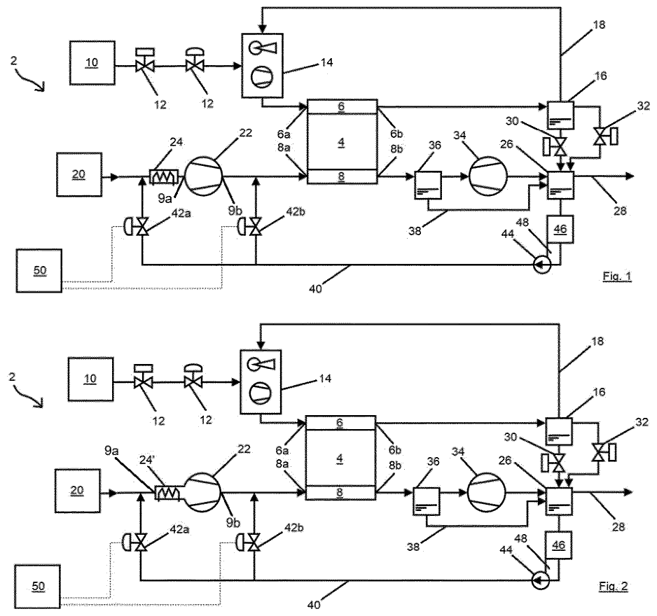

FIG. 1 represents a fuel cell system 2 according to a first embodiment of the invention. The fuel cell system 2 is suitable for equipping a vehicle as a source of electrical power.

The fuel cell system 2 comprises a fuel cell stack 4 located between an anode 6 and a cathode 8 in a generally known way, such that the basic operation of the stack 4, anode 6 and cathode 8 for producing electrical power will not be described in detail.

On the anode side, the fuel cell system 2 comprises anode supply means 10 arranged for providing an anode inlet 6a with a hydrogen-rich gas, the hydrogen being under the form of dihydrogen for example. The anode supply means 10 may comprise a tank suitable for storing such hydrogen-rich gas, an example of suitable tank is a pressurized tank. Between the anode supply means 10 and the anode inlet 6a, the fuel cell system 2 comprises one or several anodic valves 12 and a blower 14 for blowing a recirculated gas towards the anode inlet 6a. The recirculated gas is a mixture of hydrogen-rich gas, nitrogen and water vapor.

The fuel cell system 2 further comprises an anodic water separator 16 arranged downstream of an anode outlet 6b. Part of the hydrogen contained in the hydrogen-rich gas is consumed by the stack 4 at the anode 6, but the gas exiting at the anode outlet 6b still contains hydrogen, mixed with water and nitrogen. The anodic water separator 16 allows the separation of the gas exiting the anode outlet 6b into a phase of liquid water and a gaseous phase containing hydrogen, water vapor and nitrogen. The latter exits the anodic water separator 16 into an anodic recirculation duct 18 ultimately leading to the anode inlet 6a after passing through the blower 14, so as to reduce loss of hydrogen and, as such, improve the performance of the fuel cell 2. This also allows to reduce the amount of hydrogen released into an exhaust of the fuel cell system 2.

On the cathode side, the fuel cell system 2 comprises a cathode supply means 20 arranged for providing a cathode inlet 8a with a gas containing oxygen, for example air extracted from the atmosphere. Downstream of the cathode supply means 20, the fuel cell system 2 comprises an air compressor 22 for compressing the air before it is fed into the cathode inlet 8a. The air compressor 22 is housed in a housing having an air inlet 9a and an air outlet 9b. According to this embodiment, a heat exchanger 24 is arranged upstream of the air inlet 9a of the air compressor 22 and is configured to heat up the air before entering the air compressor 22, the heat exchanger 24 being preferably arranged to receive heat from a cooling circuit (not represented in the figure) of the fuel cell stack 4 in order to add value to the heat produced by the fuel cell stack 4.

The fuel cell system 2 comprises a cathodic water separator 26 arranged downstream of a cathode outlet 8b. The water produced at the cathode by reaction between the oxygen from the air and the hydrogen ion coming from the anode through the stack is separated from the gaseous flow exiting the cathode outlet so as to produce a phase of liquid water and a gaseous phase with a lower water concentration. The latter exits the fuel cell system 2 via an exhaust line 28. The anodic water separator 16 and the cathodic water separator 26 are connected by a drain valve 30 configured to allow or block the transfer of the liquid phase from the anodic water separator 16 to the cathodic water separator 26. In addition, the anodic water separator 16 is provided with a purge valve 32 configured to allow or block the transfer of the gaseous phase containing hydrogen from the anodic water separator 16 to the exhaust line 28 so as to be discharged.

Between the cathode outlet 8b and the cathodic water separator 26, the fuel cell system 2 comprises a turbine 34 arranged downstream of the cathode outlet to recover some of the energy of the gas exiting the cathode outlet 8b. The turbine 34 is arranged on a common shaft with the air compressor 22 so that energy recovered by the turbine 34 is used to power the air compressor 22. An auxiliary water separator 36 is arranged upstream of the turbine 34 to reduce the water concentration of the gas to be fed into the turbine 34 in order to reduce the risk of water droplets damaging the turbine blades. The water recovered by the auxiliary water separator 36 is transferred to the cathodic water separator 26 via an auxiliary water line 38 or, according to a variant of this embodiment (not shown), transferred straight to the buffer tank 46 (see below for more details on the buffer tank 46).

The fuel cell system 2 comprises a water recirculation duct 40 arranged to provide water to humidify the cathode inlet 8a. The water recirculation duct 40 comprises a first dosing device 42a configured to inject water upstream of the air compressor 22, and most preferably upstream of the heat exchanger 24, and a second dosing device 42b being configured to inject water downstream of the air compressor 22. The first 42a and second 42b dosing devices each comprise an injector suitable for performing water injection. The first 42a and second 42b dosing devices inject water coming from the cathodic water separator 26, which may be produced by itself or provided by the anodic water separator 16 or the auxiliary water separator 36. A water pump 44 is provided in the water recirculation duct 40 to pump the water to the first 42a and second 42b dosing devices. In addition, a buffer tank 46 is provided upstream of the water pump 44 to store the water coming from the various water separators. To prevent water from freezing in the water pump 44 and in the buffer tank 46, the fuel cell system 2 comprises a heater 48, for example an electrical heater, arranged for heating water contained in the water pump 44 and the buffer tank 46. The heater 48 may be activated at start-up of the fuel cell system 2 to thaw the water contained in the buffer tank 46.

The fuel cell system 2 comprises a control unit 50 connected to the first 42a and second 42b dosing devices so as to control the opening and the closing of the first 42a and second 42b dosing devices. The control unit 50 may also be connected to the heat exchanger 24 to control the amount of heat added to the gas upstream of the air compressor 22.

The fuel cell system 2 may be controlled as follows. Depending on parameters of the fuel cell stack 4 and the performance expected for the fuel cell system 2, i.e., required electrical power output, target parameters for the air fed into the cathode inlet 8a are determined, most importantly in temperature, pressure and water concentration.

Depending on these target parameters, the control unit 50 dynamically controls the opening and the closing of the first 42a and second 42b dosing devices so as to inject water from the first dosing device 42a at a dynamic first flow rate and to inject water from the second dosing device 42b at a dynamic second flow rate. The water injected with the first dosing device 42a goes through the heat exchanger 24, to be heated, and the air compressor 22 before being fed into the cathode inlet 8a. The water injected with the second dosing device 42b is neither heated by the heat exchanger 24 nor compressed by the air compressor 22.

Then, it is understood that if the pressure or temperature of the air entering the cathode inlet 8a is below their target value, more water should be injected with the first dosing device 42a. On the contrary, if the pressure or temperature of the air entering the cathode inlet 8a is above their target value, more water should be injected with the second dosing device 42b.

Practically, the method may involve injecting a certain quantity of water with the second dosing device 42b in order to bring the temperature at the cathode inlet 8a to a target value. Then, water is injected with the first dosing device 42a in order to bring the water concentration at the cathode inlet 8a to a target value. The heat provided to the gas by the heat exchanger 24 upstream of the air compressor 22 is adjusted to prevent the presence of water droplets that would damage the air compressor 22.

FIG. 2 represents a fuel cell system 2 according to a second embodiment of the invention. Elements of the fuel cell system 2 according to this second embodiment similar to those of the fuel cell system of the first embodiment share the same numerical references.

The fuel cell system 2 of FIG. 2 differs from the one of the previous embodiment in that the heat exchanger 24′ is arranged downstream of the air inlet 9a of the air compressor 22 such that the heat exchanger 24′ is integrated into the housing of the air compressor 22 rather than being a standalone component. In this case, the heat exchanger 24′ is arranged to receive heat from a cooling circuit (not represented in the figure) of the fuel cell stack 4 and/or from a motor of the air compressor 22, in order to add value to the heat produced by the fuel cell stack 4 and the motor of the air compressor 22. The fuel cell system 2 of FIG. 2 operates and is controlled in a manner similar to the fuel cell system of the previous embodiment.

The here-above embodiments are illustrative and not restrictive embodiments. Obviously, many modifications and variations of the present invention are possible in the light of the above teachings without deviating from its inventive concept. It has therefore to be understood that the invention may be practiced otherwise that as specifically described.

The invention is applicable to stationary equipment (e.g., power plants) and mobile equipment (e.g., road vehicles such as passenger cars and trucks, rail vehicles, water vehicles, aircrafts, spacecrafts).

An additional drain valve may be provided at an outlet of the cathodic water separator in order to transfer the water from the cathodic water separator to the buffer tank. This drain valve may be opened at shutdown of the fuel cell system to prevent the water from freezing in the cathodic water separator.

The heat exchanger may receive heat from any other heat source of the fuel cell system.

The anodic water separator and the cathodic water separator may be both individually connected to the buffer tank. In other words, the anodic water separator and the cathodic water separator may be arranged in parallel with respect to the buffer tank instead of being arranged in series as in the embodiments of FIGS. 1 and 2.

The lines of the fuel cell system may be purged at shutdown of the fuel cell system to prevent water from freezing in the lines when coping with freezing conditions.

### NUMERICAL REFERENCES

2: fuel cell system
4: fuel cell stack
6: anode
6a: anode inlet
6b: anode outlet
8: cathode
8a: cathode inlet
8b: cathode outlet
9a: air inlet
9b: air outlet
10: anode supply means
12: anodic valve
14: blower
16: anodic water separator
18: anodic recirculation duct
20: cathode supply means
22: air compressor
24: heat exchanger
26: cathodic water separator
28: exhaust line
30: drain valve
32: purge valve
34: turbine
36: auxiliary water separator
38: auxiliary water line
40: water recirculation duct
42a: first dosing device
42b: second dosing device
44: water pump
46: buffer tank
48: heater
50: control unit

1. A fuel cell system comprising:
a fuel cell stack comprising an anode and a cathode,
a cathode supply means arranged for providing a cathode inlet with a gas comprising air and water,
an air compressor arranged between the cathode supply means and the cathode,
a first dosing device and a second dosing device, the first dosing device being configured to inject water upstream of the air compressor, and the second dosing device being configured to inject water downstream of the air compressor, and
a heat exchanger arranged upstream of the air compressor, the heat exchanger being arranged to receive heat from a cooling circuit of the fuel cell stack and/or from a motor of the air compressor.

2. The fuel cell system according to claim 1, further comprising a control unit configured to control the opening and the closing of the first and second dosing devices.

3. The fuel cell system according to claim 1, further comprising a cathodic water separator, arranged downstream of a cathode outlet, the cathodic water separator being connected, directly or indirectly, to the first and second dosing devices.

4. The fuel cell system according to claim 1, further comprising an anodic water separator, arranged downstream of an anode outlet, the anodic water separator being connected, directly or indirectly, to the first and second dosing devices.

5. The fuel cell system according to claim 4, further comprising
a cathodic water separator, arranged downstream of a cathode outlet, the cathodic water separator being connected, directly or indirectly, to the first and second dosing devices, and
a drain valve arranged between the anodic water separator and the cathodic water separator.

6. The fuel cell system according to claim 1, further comprising a water pump arranged upstream of the first and second dosing devices.

7. The fuel cell system according to claim 6, further comprising a heater configured for heating the water in the pump.

8. The fuel cell system according to claim 1, wherein the first and second dosing devices each comprises an injector.

9. The fuel cell system according to claim 3, further comprising a turbine arranged downstream of the cathode outlet.

10. The fuel cell system according to claim 9, wherein the turbine is arranged on a common shaft with the air compressor.

11. The fuel cell system according to claim 9, further comprising an auxiliary water separator arranged between the cathode outlet and the turbine.

12. A vehicle comprising a fuel cell system according to claim 1.

13. A method for managing a fuel cell system according to claim 1, comprising opening and closing the first and second dosing devices to inject water partially upstream of the air compressor and partially downstream of the air compressor, and controlling the opening and the closing of the first and second dosing devices.

14. A non-transitory computer readable storage medium for storing computer instructions, wherein the computer instructions, when executed by a computer, cause the computer to implement the method according to claim 13.

15. A computer program product comprising computer program instructions, wherein the computer program instructions, when executed by a computer, cause the computer to perform the method according to claim 13.
